(19) United States
(12) Patent Application Publication
(10) Pub. No.: US 2025/0091698 A1
(43) Pub. Date: Mar. 20, 2025

(54) METHOD OF ASSEMBLING FLOATING OFFSHORE WIND VESSELS USING A MOBILE OFFSHORE ASSEMBLY FACILITY

(71) Applicant: Keppel LeTourneau USA. Inc.

(72) Inventors: Ron MACINNES, Houston, TX (US); George PRITCHARD, Houston, TX (US); Bernardino SALINAS, Brownsville, TX (US); Tak-On CHEUNG, Houston, TX (US)

(73) Assignee: Keppel LeTourneau USA. Inc., (omitted)

(21) Appl. No.: 18/175,016

(22) Filed: Sep. 15, 2023

(51) Int. Cl. B63B 77/10; B63B 21/50; B63B 35/44; B63G 8/00

(52) U.S. Cl. CPC B63B 77/10; B63B 21/50; B63B 35/44; B63B 2035/446; B63B 2221/00; B63G 8/001

(57) ABSTRACT

A method and apparatus for assembling floating offshore wind vessels is described. The method manufactures the floating offshore wind vessels at an intermediate offshore location. Sub-components of the floating offshore wind vessels are transported to a first offshore location before being assembled into a completed offshore wind vessel. The completed offshore wind vessel is transported to a second offshore location which is part of a wind field. The sub-components are assembled on a semi-submersible vessel, such as a floating dry dock.

### CROSS REFERENCE TO RELATED APPLICATIONS

This application claims priority to U.S. Provisional Patent Application 63/315,457, filed Mar. 1, 2022, which is incorporated by reference.

### BACKGROUND

### Field

Embodiments of the present disclosure generally relate to methods of manufacturing floating offshore wind installations. More particularly, the methods are directed towards manufacturing floating offshore wind turbines using a mobile offshore assembly facility.

### Description of the Related Art

Offshore wind field developments in shallow waters are growing in number and competing with other conventional energy production methods. As competition increases for shallow water wind field development locations, demand increases for floating offshore wind field developments which may be deployed in deeper water. Floating offshore wind field developments do not utilize fixed foundation structures and therefore may be deployed in water which is significantly deeper in areas with greater wind energy capacity.

Floating offshore wind vessels are currently manufactured at onshore shipyard facilities. Onshore shipyard facilities are expensive to build and maintain and often come with significant up-front costs. Up-front costs include the purchase of oceanfront property in sometimes high population areas, permitting costs, construction costs of a facility, and deconstruction costs after the usefulness of the facility is exhausted. Onshore shipyard facilities further disturb the local environment and communities around the shipyard facility.

Therefore, there is a desire to reduce manufacturing costs of floating offshore wind vessels and the utilization of onshore shipyard facilities.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the application may admit to other equally effective embodiments.

FIGS. 1A-1C are schematic plan views of an offshore construction facility and a wind field during various phases of construction, according to embodiments described herein.

FIGS. 2A-2F are schematic plan views of an offshore construction facility during various phases of wind vessel assembly, according to embodiments described herein.

FIGS. 3A and 3B are schematic side views of the offshore construction facility of FIGS. 2A-2F during assembly of turbine blades on the wind vessel assembly, according to a first embodiment described herein.

FIGS. 4A and 4B are schematic side views of a partially assembled wind vessel assembly during various phases of floating the wind vessel assembly, according to embodiments described herein.

FIGS. 5A and 5B are schematic side views of the offshore construction facility of FIGS. 2A-2F during assembly of turbine blades on the wind vessel assembly, according to a second embodiment described herein.

FIGS. 6A and 6B are perspective views of assembled wind vessels being wet towed away from the semi-submersible vessel and hulls being wet towed towards the jack-up rig, according to various embodiments described herein.

FIG. 7 is a flow diagram of a method of manufacturing floating offshore wind vessels at an offshore vessel construction facility, according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure is directed towards a method and apparatus for manufacturing floating offshore wind vessels. More specifically, embodiments described herein are directed towards the use of a mobile offshore wind vessel facility during the assembly of floating offshore wind vessels. The mobile offshore wind vessel facility includes a jack-up rig, a semi-submersible vessel, and one or more transport vessels. The jack-up rig and the semi-submersible vessel are utilized at a first offshore location to manufacture offshore wind vessels before the offshore wind vessels are transported to a wind field. The mobile offshore wind vessel facility is completed offshore and reduces the reliance on onshore facilities during manufacturing of offshore wind turbines.

The mobile offshore wind vessel facility enables the utilization of local labor and supporting services during construction of offshore wind fields. Mobile offshore wind vessel facilities are capable of being relocated and deployed in an area near the offshore wind field under construction. Therefore, offshore wind vessel assembly facilities are reusable and significantly reduce start-up construction costs at new offshore wind field facilities.

The mobile offshore wind vessel facility includes a semi-submersible vessel (e.g., dry dock), a self-elevating mobile offshore crane platform, and a large capacity crane, and may operate with one or more transport vessels. A plurality of wind vessel sub-components are supplied to the mobile offshore wind vessel facility in a disassembled state by the transport vessels and are assembled into a floating offshore wind vessel at the mobile offshore wind vessel facility.

The semi-submersible vessel provides a stable and versatile floating foundation for construction of a hull and/or base of the floating offshore wind vessel as well as installation of the wind turbine components, such as a nacelle and wind turbine blades. The semi-submersible vessel may also facilitate transportation of the floating offshore wind vessel to a standby location for vessel launch before deployment to the wind field. The semi-submersible vessel may optionally include one or more spud legs and corresponding elevating units in order to provide further stability during construction of the floating offshore wind vessel and/or during installation of the wind turbine components. In operation, the elevating units extend the spud legs until contact is made between the spud legs and the ocean floor, allowing the semi-submersible vessel to be supported by the ocean and increasing stability against metocean influences.

The self-elevating mobile offshore crane platform is a jack-up rig and is outfitted with the large capacity crane for assembly of the floating offshore wind vessels and other outfitting operations. The self-elevating mobile offshore crane platform may be configured for afloat and elevated operation. The self-elevating mobile offshore crane platforms are optimized for elevating and holding capacities, adjustable deck elevation, adjustable leg lengths, open deck space, below deck storage, and accommodation space for crew and other personnel.

The one or more transport vessels include dry tow vessels and transport barges. The one or more transport vessels carry and transport a completed floating offshore wind vessel and/or disassembled sub-components of the floating offshore wind vessel from overseas yards and/or domestic facilities to the mobile offshore wind vessel facility. The one or more transport vessels additionally carry and/or transport the completed floating offshore wind vessels to a wind field for deployment.

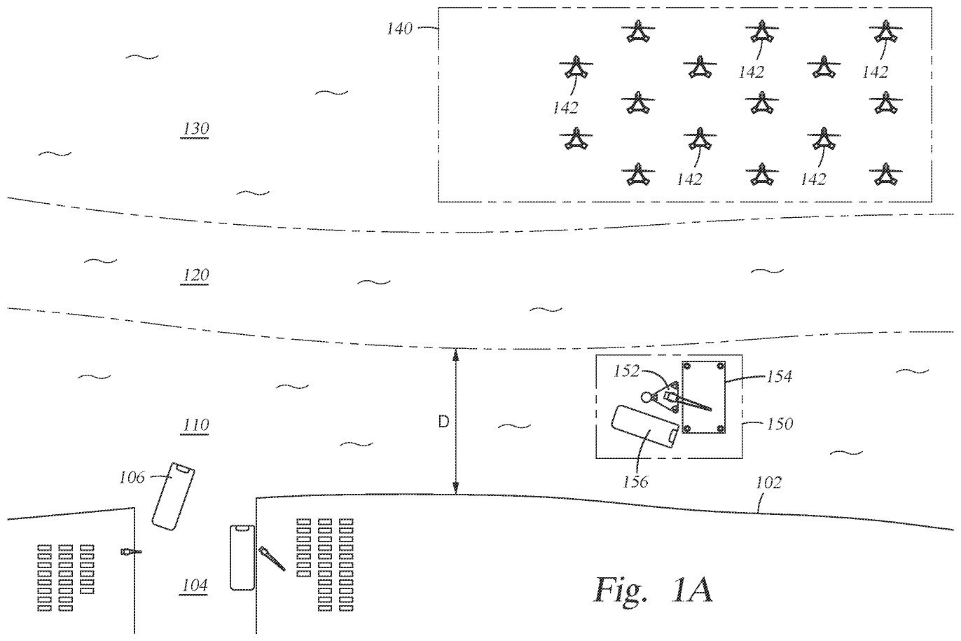

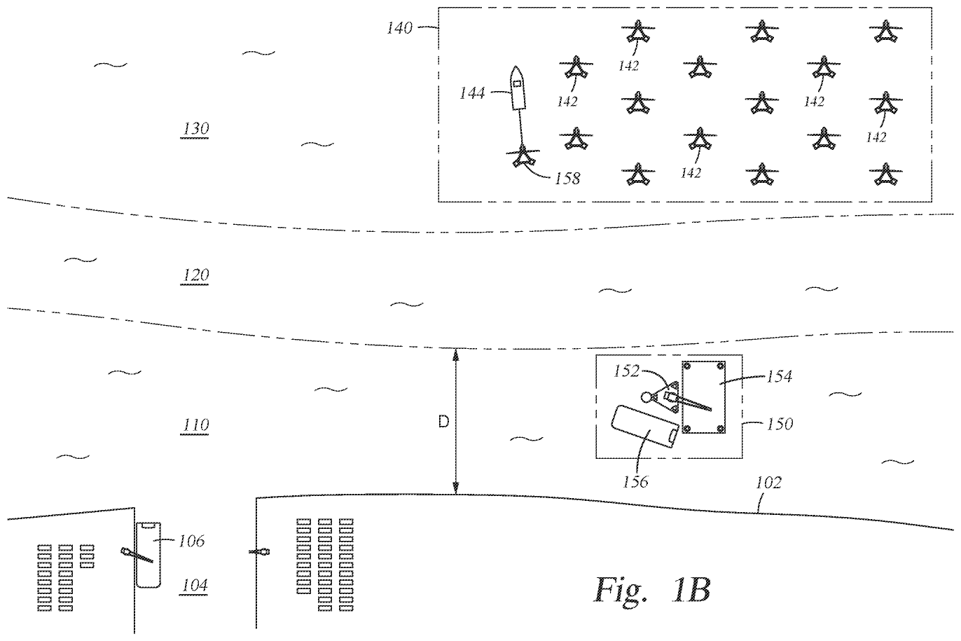

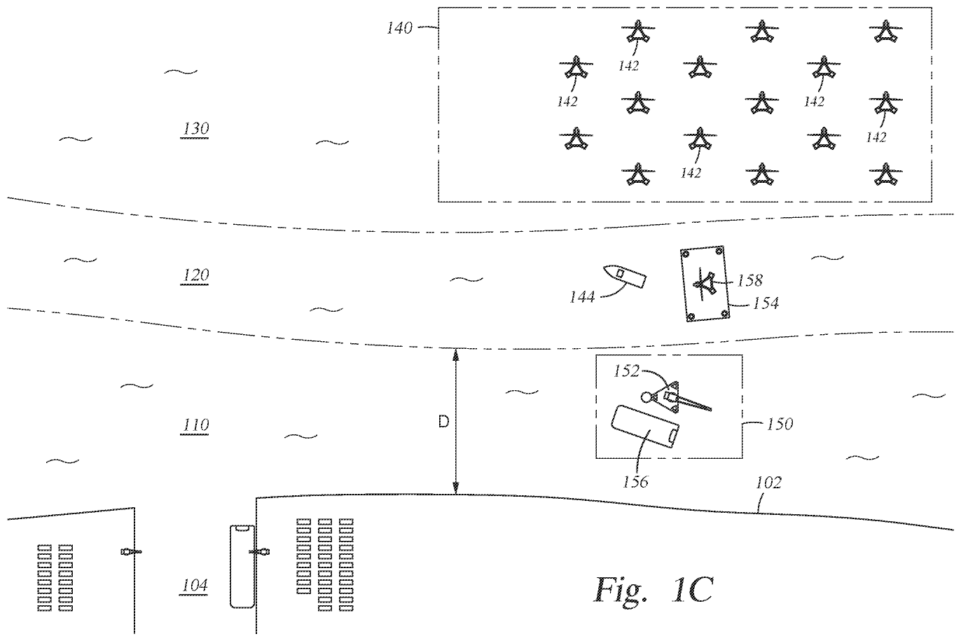

FIGS. 1A-1C are schematic plan views of an offshore construction facility 150 and a wind field 140 during various phases of wind field 140 construction. The offshore construction facility 150 is positioned at a first offshore location. The first offshore location is at a position adjacent to a coast 102. The coast 102 may include a shipyard or dock 104 from which transport vessels 106 may be loaded and unloaded. The transport vessels 106 are configured to transport and/or carry a plurality of wind vessel sub-components to the offshore construction facility 150.

The offshore construction facility 150 includes a jack-up rig 152, a semi-submersible vessel 154, and a component transport vessel 156. The offshore construction facility 150 is in a shallow water region 110. A floating offshore wind vessel 158 is assembled on top of the semi-submersible vessel 154 using the jack-up rig 152 and a plurality of wind vessel sub-components disposed on the component transport vessel 156. The shallow water region 110 has a water depth of less than about 500 feet, such as less than about 400 feet, such as less than about 300 feet, such as less than about 250 feet. The first offshore location of the offshore construction facility 150 has a first water depth. The first water depth is less than about 500 feet, such as less than about 400 feet, such as less than about 300 feet, such as less than about 250 feet, such as less than 150 feet, such as less than 100 feet, such as less than 75 feet. The water depth is generally determined by the load out draft at a construction site. The offshore construction facility is further positioned at a distance D of less than about 10 miles from the coast 102, such as less than about 6 miles from the coast 102, such as less than about 5 miles from the coast.

The wind field 140 is located at a second offshore location. The wind field 140 includes a plurality of floating offshore wind vessels 142. The wind field 140 is located in a deep water region 130. The deep water region 130 has a greater water depth than the shallow water region 110. The deep water region 130 is a region with a water depth of greater than about 200 feet, such as greater than about 300 feet, such as greater than about 400 feet, such as greater than about 500 feet, such as greater than about 600 feet. Between the deep water region 130 and the shallow water region 110 is a transition region 120. The transition region 120 has a water depth between that of the shallow water region 110 and the deep water region 130.

FIG. 1B further illustrates a second transport vessel 144 which is utilized to transport a completed floating offshore wind vessel 158 to the wind field 140 from the offshore construction facility 150 in the shallow water region 110. The second transport vessel 144 is a wet tow vessel or a transport barge. The second transport vessel 144 may be the same as the transport vessel 106 or the component transport vessel 156. The floating offshore wind vessel 158 may be wet towed behind the second transport vessel 144 to the wind field 140. In some embodiments, a dry tow vessel that is appropriately sized to meet the afloat stability requirements for offshore transit of a completed floating offshore wind vessel 158 may transport the completed floating offshore wind vessel 158 from the offshore construction facility 150 to the wind field 140.

FIG. 1C illustrates the offshore construction facility 150, the transition region 120, and the wind field 140 when the semi-submersible vessel 154 is also utilized to transport the completed floating offshore wind vessel 158 from the offshore construction facility 150 to the transition region 120. The completed floating offshore wind vessel 158 is assembled at the offshore construction facility 150 before moving the semi-submersible vessel 154 to the transition region 120. The semi-submersible vessel 154 is then ballasted, and the completed floating offshore wind vessel 158 is off-loaded in the transition region 120. The completed floating offshore wind vessel 158 may then be wet towed from the transition region 120 to the wind field 140 by another vessel, such as the second transport vessel 144.

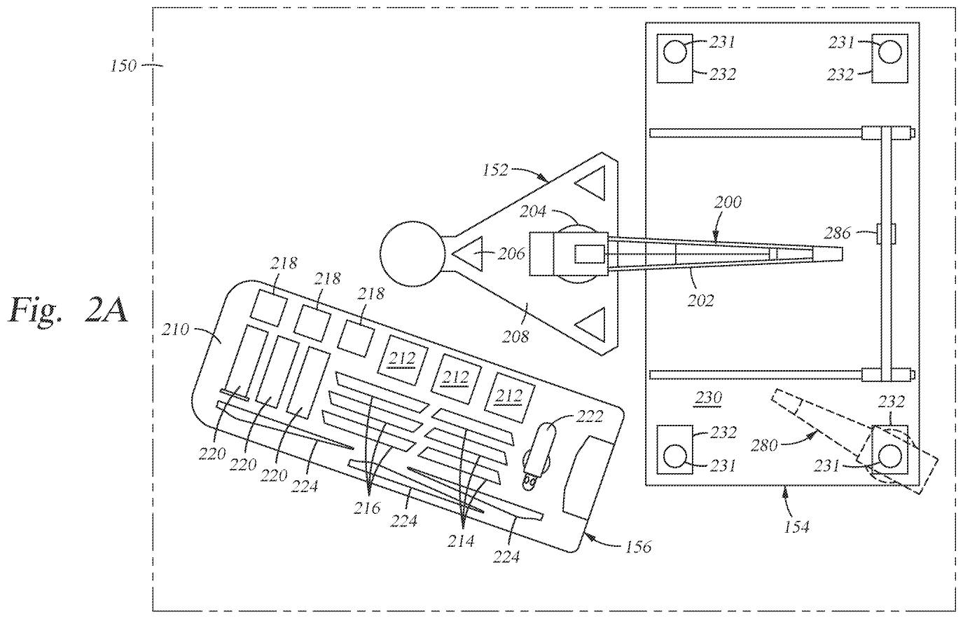

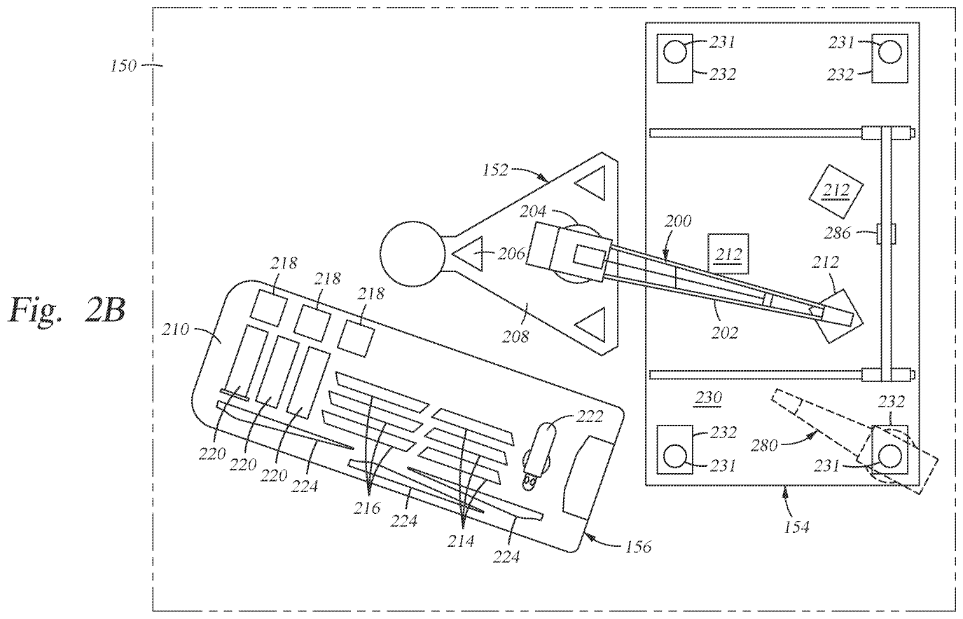

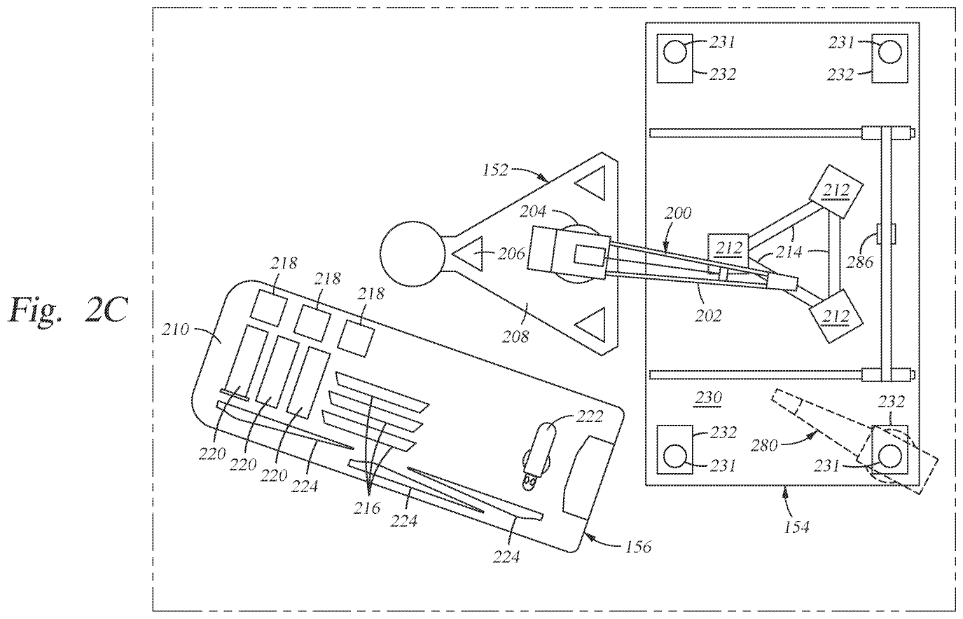

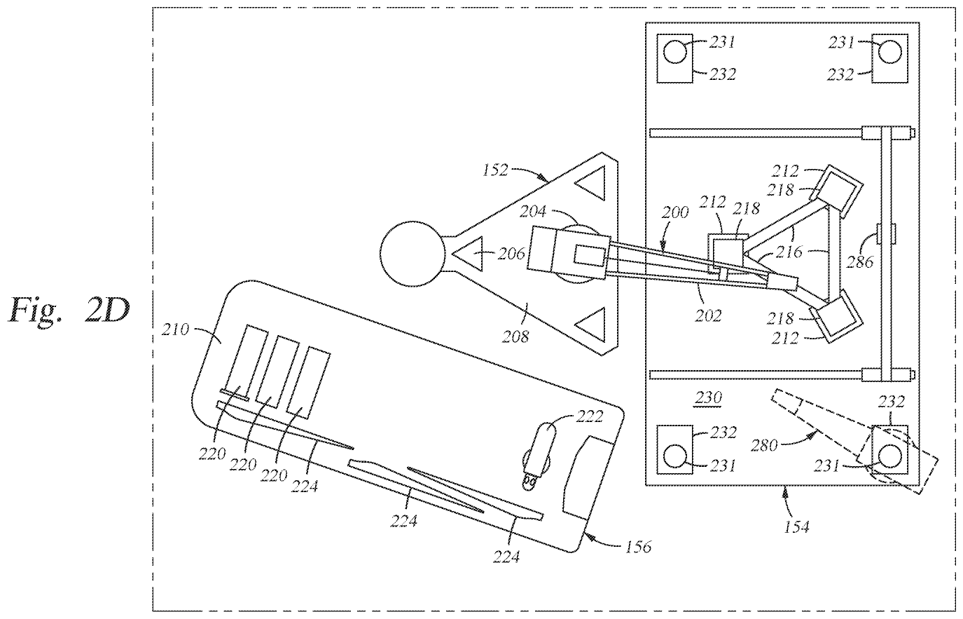

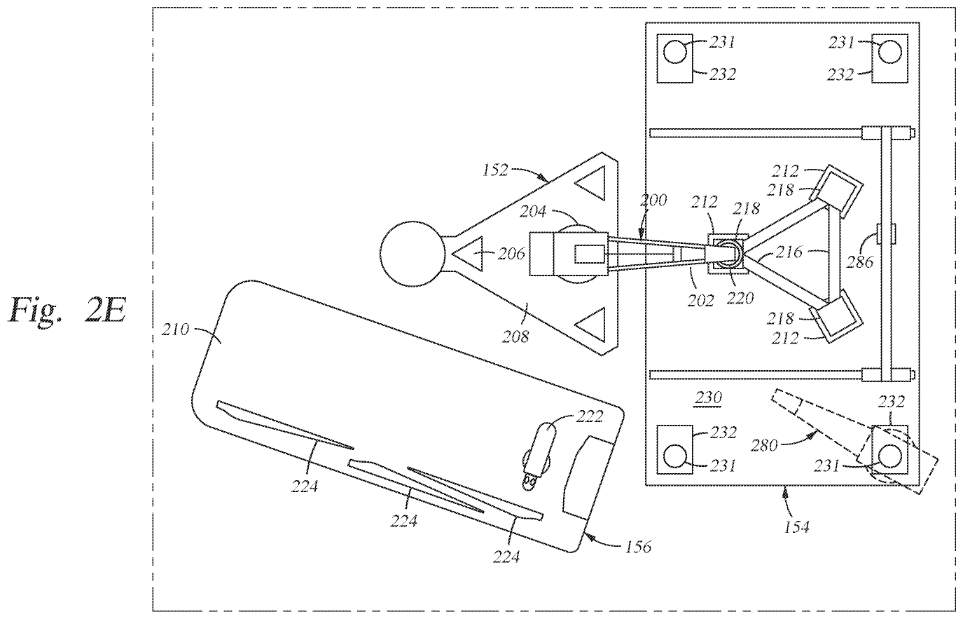

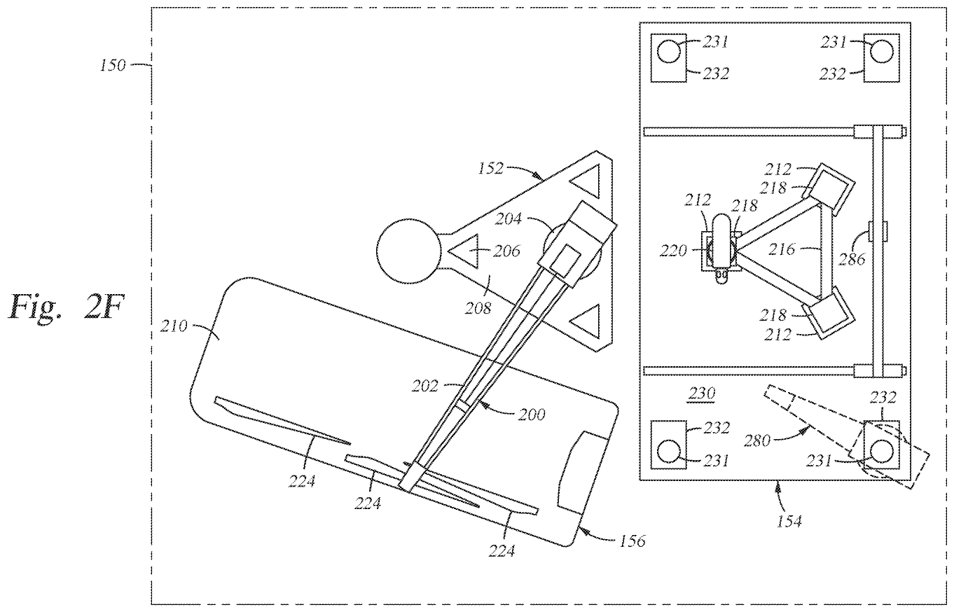

FIGS. 2A-2F are schematic plan views of an offshore construction facility 150 during various phases of wind vessel assembly. The offshore construction facility includes the jack-up rig 152, the semi-submersible vessel 154, and the component transport vessel 156. The jack-up rig 152 is configured to transport wind vessel sub-components from the component transport vessel 156 to the semi-submersible vessel 154. The jack-up rig 152 further assists in assembly of a wind vessel on the semi-submersible vessel 154 after transport of one or more wind vessel sub-components from the component transport vessel 156. FIG. 2A is a first plan view of the offshore construction facility 150 before any wind vessel sub-components are moved from the component transport vessel 156 to the semi-submersible vessel 154.

The jack-up rig 152 includes a crane 200. The crane 200 is a large capacity crane. In some embodiments, a large capacity crane may encircle and/or couple to an adjustable leg 206 of the jack-up rig 152, or two or more lower capacity cranes may encircle and/or couple to two or more of the adjustable legs 206 of the jack-up rig 152. The crane 200 is configured to utilize a fast line (auxiliary hoist) for light lifts and a main hoist for heavy lifts. The crane 200 is positioned on or above the rig's main deck 208. The main deck 208 is the top surface of the jack-up rig 152, which may be, for example, a multi-legged jack-up rig (e.g., a three-legged rig, a four-legged rig, etc.). A crane base 204 is disposed on and/or through the main deck 208. A crane arm 202 extends outward from the crane base 204, such that the crane arm 202 extends radially outward from a central axis formed by the crane base 204. The crane arm 202 extends outward of an outer perimeter of the jack-up rig 152 and the main deck 208 of the jack-up rig 152. The crane arm 202 may also be referred to as a boom or jib of the crane 200. A plurality of adjustable legs 206 are disposed through a body of the jack-up rig 152 and the main deck 208. The plurality of adjustable legs 206 are configured to enable raising and lowering of the jack-up rig 152 relative to an ocean floor. The plurality of adjustable legs 206 are coupled to a portion of an ocean floor below the jack-up rig 152.

The semi-submersible vessel 154 includes an assembly deck 230, a plurality of spud legs 231, a plurality of elevating units 232, and a gantry crane 286. The assembly deck 230 is configured to be a planar or mostly planar surface in the center of the semi-submersible vessel 154. The assembly deck 230 is where a wind turbine is configured to be constructed. In some embodiments, the assembly deck 230 is large enough to support the simultaneous construction of two or more wind turbines. The plurality of elevating units 232 are disposed on each corner of the semi-submersible vessel 154. The plurality of elevating units 232 are configured to extend the spud legs 231 towards the ocean floor in order to provide stability to the semi-submersible vessel 154 and to enable the assembly deck 230 to be raised relative to the ocean floor (e.g., raised above the ocean waterline and/or submerged below the ocean waterline). In some embodiments, the plurality of elevating units 232 are configured to extend the spud legs 231 to enable the assembly deck 230 to be raised to an elevation where the draft is less than a floating draft where the legs are not in contact with the ocean floor. In FIGS. 2A-2F, the spud legs 231 are in contact with the ocean floor, and the assembly deck 230 of the semi-submersible vessel 154 is positioned above the ocean waterline. When the semi-submersible vessel 154 is generally rectangular or when the assembly deck 230 has a rectangular shape, four elevating units 232 and corresponding spud legs 231 may be implemented, with one elevating unit 232 located at each corner of the rectangular semi-submersible vessel 154.

Each elevating unit 232 is configured to assist in balancing and stabilizing of the semi-submersible vessel 154. Additionally, other construction modules, such as one or more tower cranes 280 may be coupled to and/or encircle one or more of the elevating units 232. The housings of the elevating units 232 may also include and/or provide structural support for generators and pumps for ballasting and de-ballasting the semi-submersible vessel 154. A gantry crane 286 is disposed between two edges of the assembly deck 230 and is configured to be moveable along a length of the semi-submersible vessel 154 and the assembly deck 230.

The gantry crane 286 includes two or more girders 288 disposed across the width of the assembly deck 230 of the semi-submersible vessel 154 to form a bridge across the assembly deck 230. The girders 288 include a drive girder and an idler girder. The drive girder includes one or more actuators or drivers coupled thereto. The actuators and/or drivers are configured to actuate a trolley 290 between the girders 288. An end tuck is disposed at either end of the girders 288. The end tuck assists in moving the gantry crane 286 along the length of the assembly deck 230 and include one or more actuators and/or one or more wheels. The trolley 290 is disposed between the girders 288 and configured to actuate along the length of the girders 288 during assembly of a wind vessel. The trolley 290 includes a hoist, a trolley drive, an upper block, and a hood block. The semi-submersible vessel 154 is a shape or size suitable for use during assembly of a wind vessel. The semi-submersible vessel 154 may therefore be an ovoid or circular shape.

The component transport vessel 156 includes a transport vessel deck 210. The transport vessel deck 210 is a top deck of the component transport vessel 156. The transport vessel deck 210 is a mostly planar surface configured to receive a plurality of wind vessel sub-components. The wind vessel sub-components may include, without limitation, a plurality of lower columns 212, a plurality of upper columns 218, a plurality of lower braces 216, a plurality of upper braces 214, one or more wind vessel column components 220, a nacelle 222, and a plurality of turbine blades 224. The plurality of lower columns 212 and the plurality of lower braces 216 form a vessel base. The plurality of upper columns 218 and the plurality of upper braces 214 form an upper support base. The combination of each of the lower columns 212, the plurality of lower braces 216, the plurality of upper columns 218, and the plurality of upper braces 214 form a hull of the wind vessel. The one or more wind vessel column components 220 form a vessel column. In general, the transport vessel deck 210 may receive, store, and/or transport sub-components associated with any type or design of wind vessel. The foregoing wind vessel sub-components are therefore described only as exemplary components that may be implemented with the offshore construction facility 150.

The lower column 212 and the upper columns 218 are configured to enable an assembled wind vessel to float and include volumes therein which enable control of the buoyancy of the wind vessel. The wind vessel as described herein is a semi-submersible wind turbine. Other types of wind vessels may also be manufactured using a similar method and components as described herein, such as a ballast stabilized/spar-buoy wind turbine, a buoyancy stabilized/barge wind turbine, or a tension leg/mooring line stabilized wind turbine.

FIG. 2B is a second plan view of the offshore construction facility 150 after moving the plurality of lower columns 212 onto the semi-submersible vessel 154 from the component transport vessel 156. The lower columns 212 are moved into place using a combination of one or more of the crane 200, the gantry crane 286, and one or more optional tower cranes 280 that are coupled to and/or encircle the elevating units 232. FIG. 2C is a third plan view of the offshore construction facility 150 after moving the plurality of lower braces 216 onto the semi-submersible vessel 154 and assembling the lower braces 216 with the lower columns 212 to form the vessel base. The lower braces 216 are moved into place using a combination of one or more of the crane 200, the gantry crane 286, and the optional tower crane(s) 280.

FIG. 2D is a fourth plan view of the offshore construction facility 150 after moving the plurality of upper columns 218 and the plurality of upper braces 214 onto the semi-submersible vessel 154 from the component transport vessel 156. The plurality of upper columns 218 and the plurality of upper braces 214 are assembled on top of the vessel base, such that a hull 250 is formed. The upper columns 218 and the upper braces 214 are moved into place using a combination of one or more of the crane 200, the gantry crane 286, and the optional tower crane(s) 280. FIG. 2E is a fifth plan view of the offshore construction facility 150 after moving the one or more wind vessel column components 220 onto the semi-submersible vessel 154 from the component transport vessel 156. The wind vessel column components 220 are moved into place using a combination of one or more of the crane 200, the gantry crane 286, and the optional tower crane(s) 280. The wind vessel column components 220 are assembled as a single column on top of one of the upper columns 218. FIG. 2F is a sixth plan view of the offshore construction facility 150 after moving the nacelle 222 onto the semi-submersible vessel 154 from the component transport vessel 156. The nacelle 222 is moved into place using a combination of one or more of the crane 200, the gantry crane 286, and the optional tower crane(s) 280. The nacelle 222 is placed on top of the column formed by the wind vessel column components 220. The combination of the hull 250, the wind vessel column components 220, and the nacelle 222 forms a first portion 270 of a floating offshore wind vessel.

In some embodiments, the semi-submersible vessel 154 is also utilized as the component transport vessel 156. In this embodiment, the semi-submersible vessel 154 is utilized both to transport wind vessel sub-components to the offshore construction facility 150 and build the wind vessel. In this embodiment, the semi-submersible vessel 154 is utilized to assemble a wind vessel on the semi-submersible vessel 154 without moving the wind vessel sub-components off of a separate component transport vessel 156. It is contemplated that the semi-submersible vessel 154 may be Jones Act compliant to facilitate operation within United States waters.

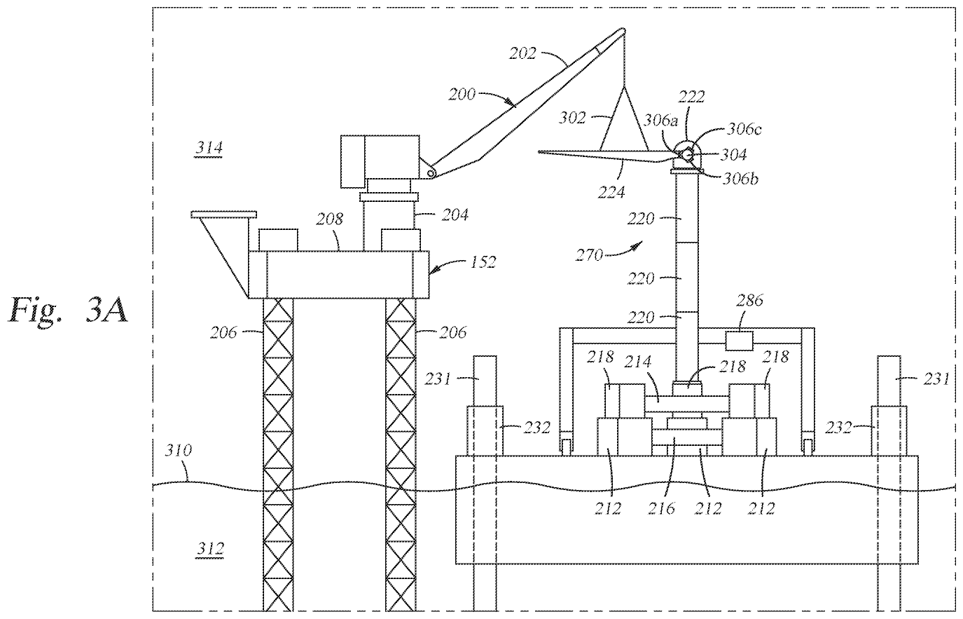

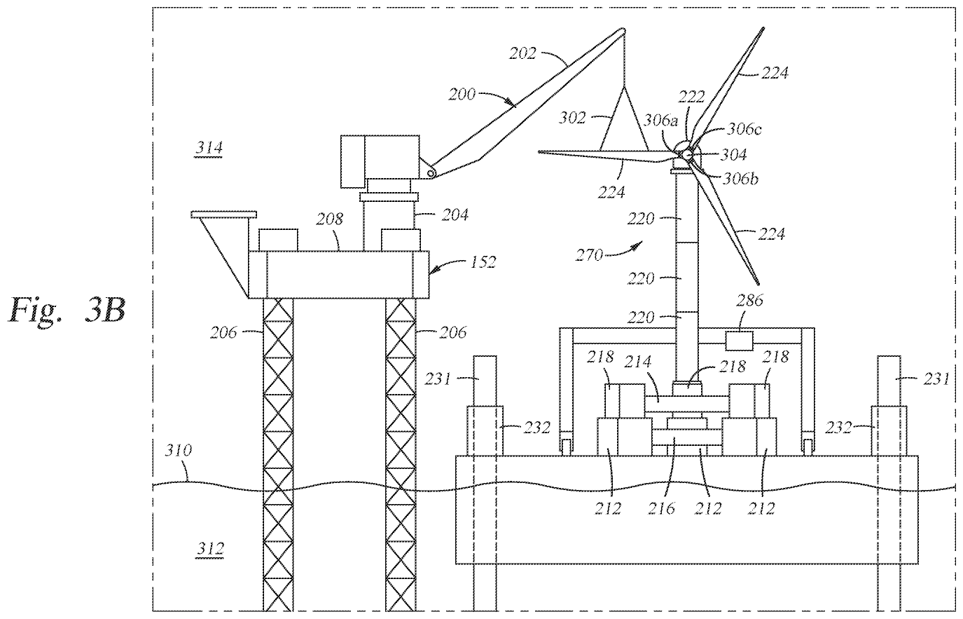

FIGS. 3A and 3B are schematic side views of the offshore construction facility of FIGS. 2A-2F during assembly of turbine blades 224 on the first portion 270 of the floating offshore wind vessel. As shown in FIGS. 3A and 3B, the turbine blades 224 are assembled onto the first portion 270 as the first portion 270 is positioned on the semi-submersible vessel 154. As shown, the elevating units 232 and corresponding spud legs 231 have raised the assembly deck 230 and the first portion 270 of the floating offshore wind vessel above a waterline 310 and out of the water 312. The assembly deck 230 and the first portion 270 are disposed in the air 314.

Each of the turbine blades 224 are configured to be attached to one of a plurality of attachment surfaces 306a, 306b, 306c on a rotor hub 304 of the nacelle 222. Each of the plurality of attachment surfaces 306a, 306b, 306c are disposed on different sides of the rotor hub 304. The plurality of attachment surfaces 306a, 306b, 306c include a first attachment surface 306a, a second attachment surface 306b, and a third attachment surface 306c. As shown in FIG. 3A, a first turbine blade 224 is coupled to the first attachment surface 306a. One or more hooks or hoist lines 302 are configured to couple to the first turbine blade 224 and enable lifting of the first turbine blade 224 during assembly with the first portion 270 of the floating offshore wind vessel.

In various embodiments, a partially assembled wind vessel (e.g., including the first portion 270 assembled onto hull 250) may be floated in by a dry-tow vessel and positioned on an assembly deck 230 of the semi-submersible vessel 154 for the final outfitting of the wind turbine components (e.g., turbine blades 224). In some embodiments, the partially assembled wind vessel includes a lower platform (e.g., hull 250), a vessel column 220, (optionally) a nacelle 222, and turbine blades 224 are assembled on the partially assembled wind vessel on the assembly deck 230 to form a completed wind vessel 350.

FIG. 3B illustrates the floating offshore wind vessel after assembling each of the turbine blades 224 onto the rotor hub 304. Therefore, the first turbine blade 224 is attached to the first attachment surface 306a, a second turbine blade 224 is attached to the second attachment surface 206b, and a third turbine blade 224 is attached to the third attachment surface 206c. The rotor hub 204 is rotated as the turbine blades 224 are assembled thereon. One or a combination of the turbine blades 224 and the nacelle 222 are referred to as a second portion of the wind vessel. Once the turbine blades 224 are assembled onto the rotor hub 304, a completed wind vessel 350 is formed. The completed wind vessel 350 is a completed offshore wind vessel.

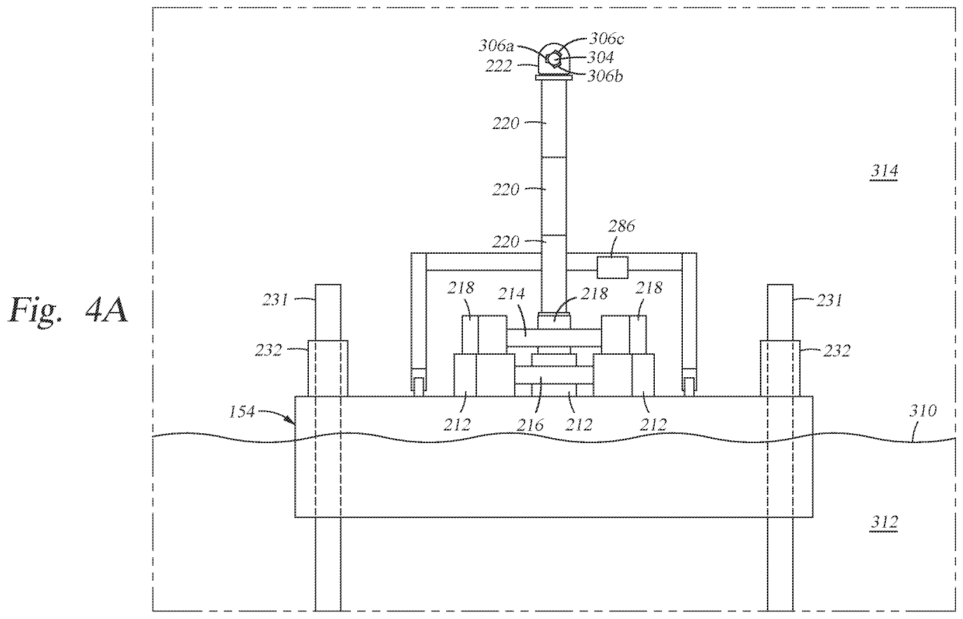

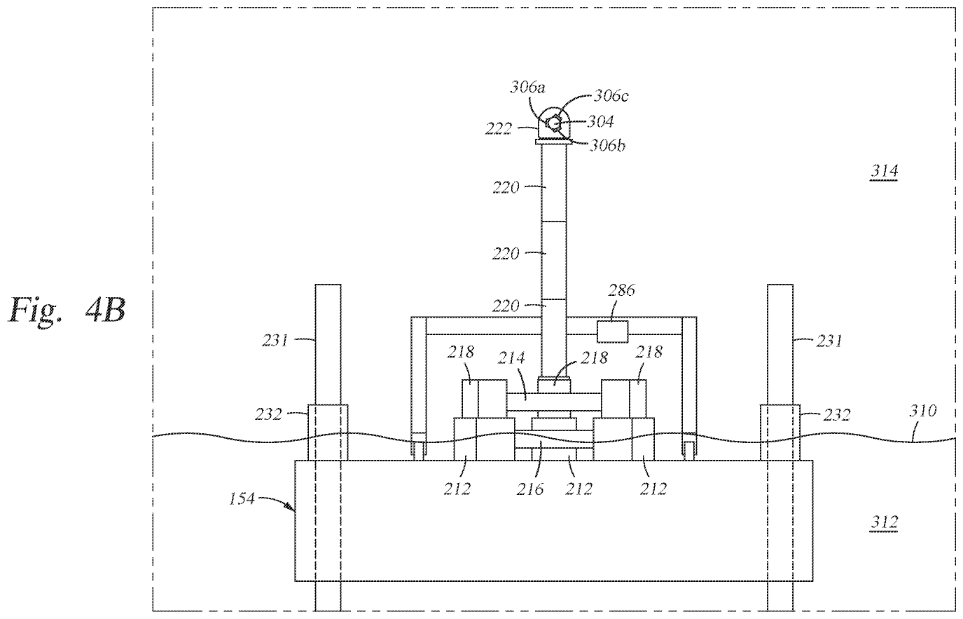

FIGS. 4A and 4B are schematic side views of the first portion 270 of an assembled wind vessel during various phases of floating the first portion 270 of the wind vessel. As shown in FIG. 4A, the first portion 270 of the wind vessel is disposed on the assembly deck 230 while the assembly deck 230 is disposed above the waterline 310 and out of the water 312. The first portion 270 of the wind vessel is assembled in the position illustrated in FIG. 4A. After assembly of the first portion 270, the elevating units 232 retract the spud legs 231 away from the ocean floor, causing the semi-submersible vessel 154 to be at least partially submerged such that the assembly deck 230 is below the waterline 310, as shown in FIG. 4B. By moving the assembly deck 230 below the waterline 310, the first portion 270 of the wind vessel is positioned in the water 312 and then floated off of the assembly deck 230 into the water 312. Sinking the assembly deck 230 below the waterline 310 disengages the first portion 270 of the wind vessel from the assembly deck 230 and the semi-submersible vessel 154.

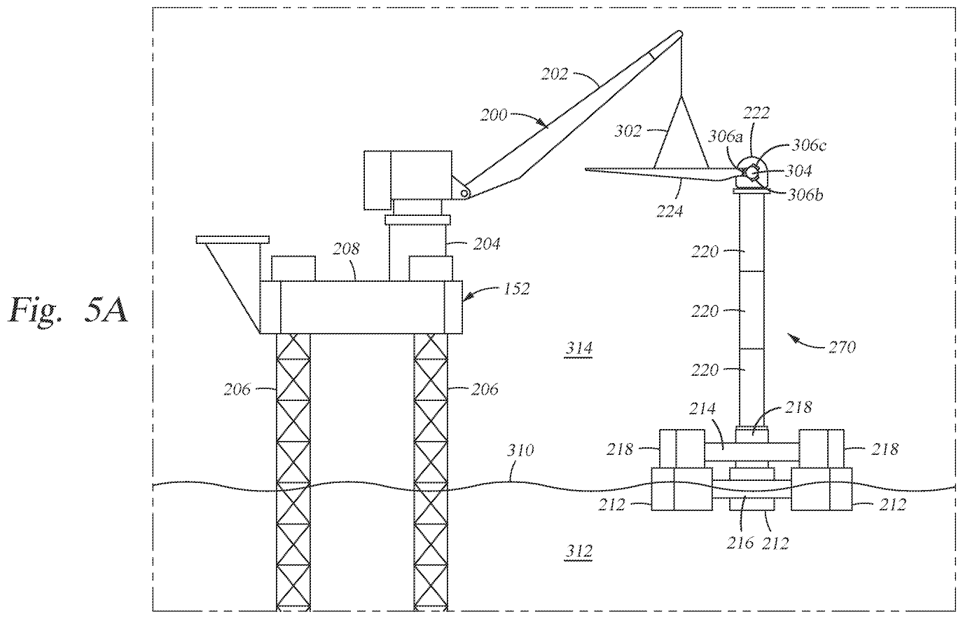

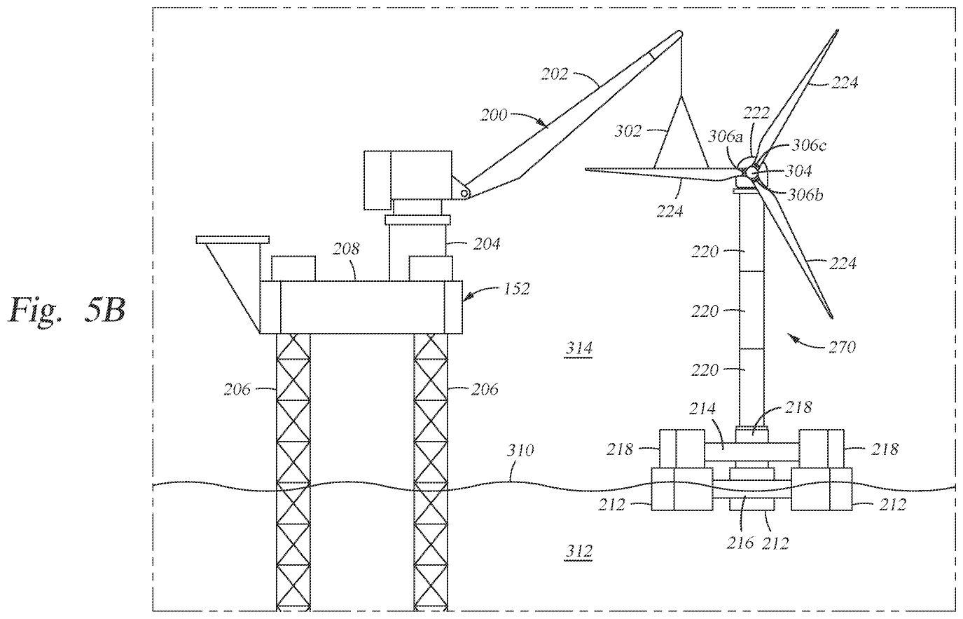

FIGS. 5A and 5B are schematic side views of the offshore construction facility of FIGS. 2A-2F during assembly of turbine blades 224 on the first portion 270 of the wind vessel. The assembly of the turbine blades 224 on the first portion 270 is similar to the assembly as shown in FIGS. 3A and 3B, but the turbine blades 224 are attached to the rotor hub 304 after the first portion 270 has been floated off of the semi-submersible vessel 154, such that the first portion 270 is partially submerged in the water 312. In some embodiments, prior to attaching the turbine blades 224 to the first portion 270, the first portion 270 is ballasted and/or coupled to the ocean floor in order to provide additional stability. Therefore, FIGS. 3A and 3B illustrate a first embodiment of how to assemble the completed wind vessel 350, while FIGS. 4A, 4B, 5A, and 5B illustrate a second embodiment of how to assembly the completed wind vessel 350. The first embodiment floats the completed wind vessel 350 off of semi-submersible vessel 154 after the turbine blades 224 are attached. The second embodiment floats the first portion 270 of the wind vessel off of the semi-submersible vessel 154 before adding the turbine blades 224 to form the completed wind vessel 350. As shown in FIG. 5A, a first turbine blade 224 is attached to the first attachment surface 306a. As shown in FIG. 5B, a second turbine blade 224 and a third turbine blade 224 are attached to a second attachment surface 306b and a third attachment surface 306c respectively. Therefore, the completed wind vessel 350 is already floated in the water 312 once each of the turbine blades 224 are attached to the rotor hub 304. The completed wind vessel 350 is utilized as the floating offshore wind vessel 158.

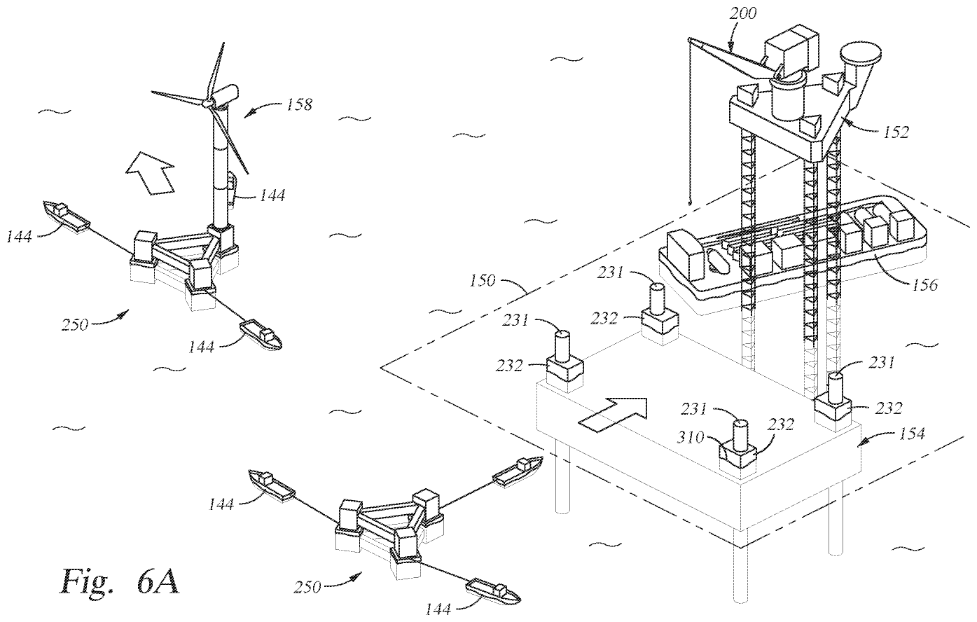

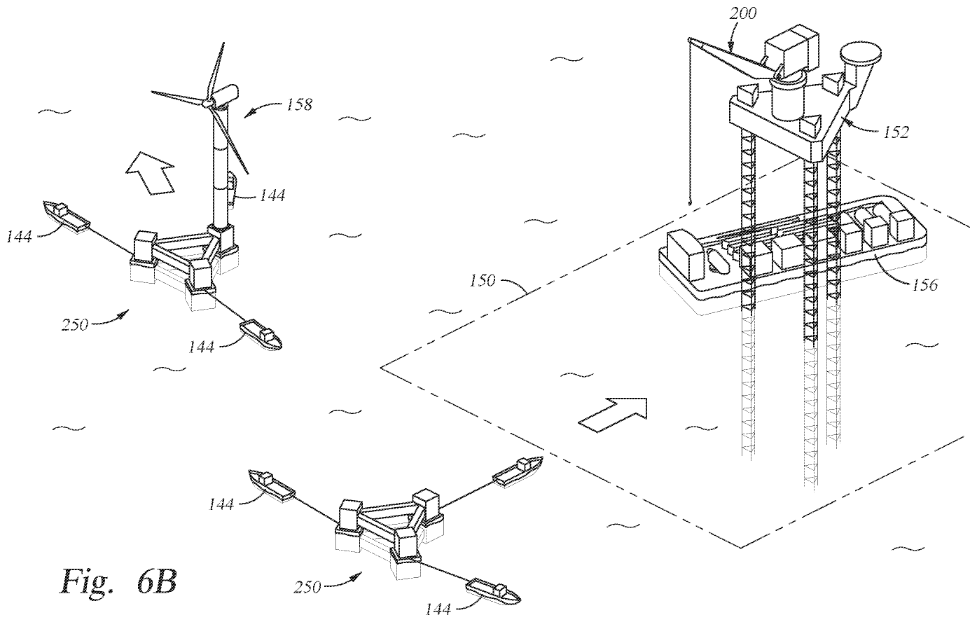

FIGS. 6A and 6B are perspective views of assembled wind vessels being wet towed away from the semi-submersible vessel 154 and hulls 250 being wet towed towards the jack-up rig 152. The hull 250 may include, for example, the plurality of lower columns 212, the plurality of upper columns 218, the plurality of lower braces 216, and the plurality of upper braces 214.

As shown in FIG. 6A, the hull 250 is wet towed to the semi-submersible vessel 154 and loaded onto the assembly deck 230 while the assembly deck 230 is at least partially submerged below the waterline 310, similar to the position of the assembly deck 230 shown in FIG. 4B. Prior to assembly of the wind vessel sub-components, the hull 250 may be ballasted and/or coupled to the assembly deck 230 while the assembly deck is submerged in order to provide stability during subsequent assembly of wind vessel components. The one or more wind vessel column components 220, the nacelle 222, and the plurality of turbine blades 224 may then be assembled on the hull 250 to form a completed wind vessel 350. Alternatively, the elevating units 232 may extend the spud legs 231 towards the ocean floor in order to elevate the assembly deck 230 above the waterline 310 so that the hull 250 is resting in a stable position on top of the assembly deck 230, similar to the position of the assembly deck 230 shown in FIG. 4A. The one or more wind vessel column components 220, the nacelle 222, and the plurality of turbine blades 224 may then be assembled on the hull 250 to form a completed wind vessel 350. The completed wind vessel 350 may then be wet towed away from the semi-submersible vessel 154, and a new hull 250 may be wet towed to the assembly deck 230. Transporting preassembled hulls 250 to the semi-submersible vessel 154 for final assembly of wind turbine components may increase overall throughput relative to assembling the hull 250 itself on the semi-submersible vessel 154.

As shown in FIG. 6B, the hull 250 is wet towed to the jack-up rig 152, but is not loaded onto an assembly deck. Instead, the hull 250 may be ballasted and/or coupled to the ocean floor to provide stability for subsequent assembly of the wind vessel components. The one or more wind vessel column components 220, the nacelle 222, and the plurality of turbine blades 224 may then be assembled on the hull 250 to form a completed wind vessel 350. The completed wind vessel 350 may then be wet towed away from the jack-up rig 152, and a new hull 250 may be wet towed to the jack-up rig 152.

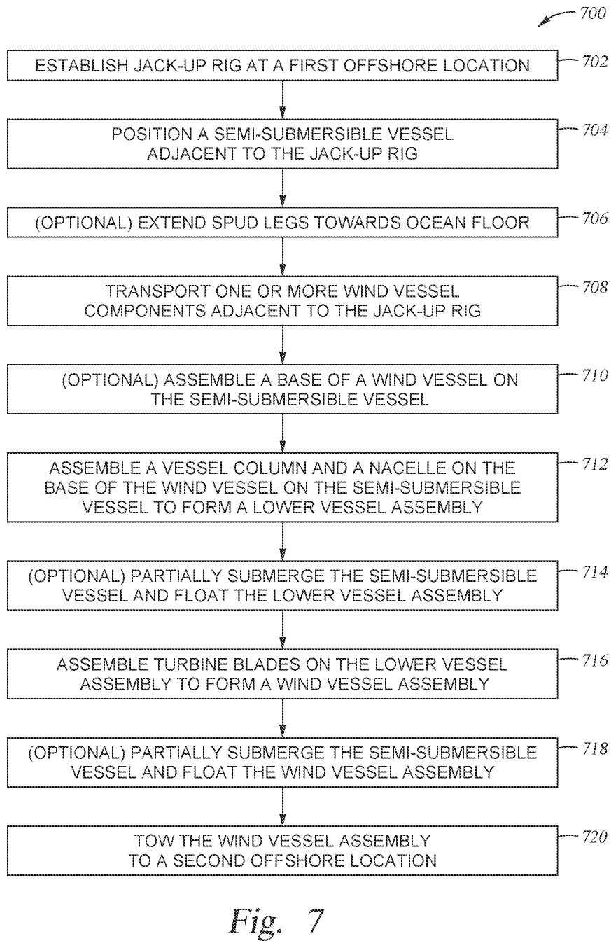

FIG. 7 is a flow diagram of a method 700 of manufacturing floating offshore wind vessels, such as one of the completed wind vessels 350 or the floating offshore wind vessel 158, at an offshore vessel construction facility, such as the offshore vessel construction facility 150. The method 700 is utilized for assembling the floating offshore wind vessel at an intermediate location, such as at a first offshore location before moving the floating offshore wind vessel to a second offshore location which is in a deeper water location or is further from the shore. By assembling the floating offshore wind vessel at an offshore site, capital expenditure is reduced for development of onshore shipyard infrastructure. Local labor and supporting services is also more fully utilized with offshore wind vessel assembly. Assembling the floating offshore wind vessel at an offshore location further avoids development of land onshore which often calls for government agency approval, permitting, impact studies, and building costs. Land based infrastructure construction may further negatively impact the local community and environment.

During a first operation 702 of the method 700, a jack-up rig, such as the jack-up rig 152, is established at a first offshore location. Establishing the jack-up rig includes transporting the jack-up rig to the first offshore location before lowering one or more adjustable legs, such as the adjustable legs 206, into the ocean and coupling the jack-up rig to a portion of the ocean floor below the jack-up rig. The jack-up rig may be transported to the first offshore location and forms a part of an offshore construction facility 150. The depth of the ocean at the first offshore location is shallow enough to enable the jack-up rig to be established, such that the water is shallow enough to enable a platform of the jack-up rig and a crane to be above the water line while a bottom of the adjustable legs 206 contacts the ocean floor. The jack-up rig may be transported from an on-shore location (e.g., a seaport or harbour) or a different offshore location, such as a previous offshore construction site.

After the jack-up rig is established, a semi-submersible vessel, such as the semi-submersible vessel 154, is positioned adjacent to the jack-up rig during an operation 704. The semi-submersible vessel is transported from a different location. The different location may be an on-shore location or a different offshore location, such as a previous offshore construction site. The combination of the jack-up rig and the semi-submersible vessel forms the offshore construction facility. After the second operation 704, spud legs, such as spud legs 231, of the semi-submersible vessel are extended towards the ocean floor during operation 706. The spud legs are optional and provide stability to an assembly deck of the semi-submersible vessel during assembly of the wind vessel. After extension of the spud legs, an assembly deck of the semi-submersible vessel may be positioned above a waterline of the ocean, as described in conjunction with FIGS. 2A-2F, or the assembly deck of the semi-submersible vessel may be positioned below a waterline of the ocean, as described in conjunction with FIG. 6A.

After the operation 706, one or more wind vessel components are transported to the first offshore location and adjacent to the jack-up rig during an operation 708. The one or more wind vessel components include one or a combination of each of the plurality of lower columns 212, the plurality of upper columns 218, the plurality of lower braces 216, the plurality of upper braces 214, the one or more wind vessel column components 220, the nacelle 222, and the plurality of turbine blades 224. It is contemplated that additional components may be transported to facilitate completion of the wind turbines. In some embodiments, the one or more wind vessel components transported to the first offshore location and adjacent to the jack-up rig include a preassembled hull 250, the one or more wind vessel column components 220, the nacelle 222, and the plurality of turbine blades 224, as described in conjunction with FIGS. 6A and 6B.

In some embodiments, each of the one or more wind vessel components are transported to the first offshore location using a single transport vessel. In other embodiments, multiple transport vessels are utilized, with each transport vessel carrying different components. In some embodiments, the semi-submersible vessel includes a plurality of wind vessel sub-components already positioned thereon during the second operation 704, such that the semi-submersible vessel is transported from a port with the wind vessel sub-components to the first offshore location.

After the operation 708, a hull of a wind vessel is optionally assembled, such as the hull 250 during an operation 710. The hull of the wind vessel includes the portions of the wind vessel which maintain buoyancy of the wind vessel. The hull of the wind vessel is assembled using one of a crane on the jack-up rig, a gantry crane on the semi-submersible vessel, and one or more optional tower cranes coupled to or encircling elevating units of the semi-submersible vessel. Alternatively, as described in operation 708, a hull of the wind vessel may be transported to the first offshore location in a preassembled form and, thus, does not require assembly in operation 710.

After operation 710, a vessel column and a nacelle are assembled onto the hull of the wind vessel during the operation 712. The vessel column and the nacelle are positioned on the hull of the wind vessel while the hull of the wind vessel is positioned on the assembly deck of the semi-submersible vessel. The assembly of the vessel column, the nacelle, and the hull of the wind vessel is a lower vessel assembly, such as the first portion 270. The vessel column and the nacelle are similarly assembled onto the hull using one of a combination of a crane on the jack-up rig, the gantry crane, and the optional tower crane(s).

After assembling the lower vessel assembly, the semi-submersible vessel is at least partially submerged to float the lower vessel assembly during an operation 714. The operation 714 is optional and only performed in embodiments where the wind vessel is floated before attachment of one or more turbine blades, such as in the embodiments of FIGS. 4A, 4B, 5A, and 5B. Floating the lower vessel assembly includes sinking an assembly deck, such as the assembly deck 230, below the waterline of the ocean. Therefore, the assembly deck is submerged in the water and the lower vessel assembly becomes at least partially submerged. Partially submerging the lower vessel assembly enables the lower vessel assembly to be floated off of the assembly deck and one of the semi-submersible vessel or the lower vessel assembly is moved such that the lower vessel assembly is no longer positioned over the semi-submersible vessel.

After one or both of the operation 712 and the operation 714, a plurality of turbine blades are attached to the lower vessel assembly during an operation 716. Attaching the plurality of turbine blades forms a wind vessel assembly, such as the completed wind vessel 350. Embodiments of the assembly of the turbine blades onto the wind vessel assembly are illustrated in FIGS. 3A, 3B, 5A,5B, 6A, and 6B. The turbine blades are attached to a rotor hub. The turbine blades are assembled onto the rotor hub and the lower vessel assembly using one of a combination of a crane on the jack-up rig, the gantry crane, and the optional tower crane(s).

In embodiments wherein the lower vessel assembly was not floated during the operation 714, the semi-submersible vessel is at least partially submerged during an operation 718 after assembling the turbine blades onto the lower vessel assembly during the operation 716. The operation 718 is performed in embodiments where the wind vessel is floated after being fully assembled, such as the embodiments of FIGS. 3A and 3B. Floating the fully assembled wind vessel is similar to floating the lower vessel assembly in operation 714.

After fully assembling and floating the wind vessel during the operations 714, 716, 718, the wind vessel assembly is transported to a second offshore location during an operation 720. The second offshore location is the location of a wind field, such as the wind field 140. The second offshore location may be in a deep water region, such as the deep water region 130. Transporting the completed wind vessel to the second offshore location is performed after the wind vessel is assembled in order to enable assembly of the wind vessel at an offshore location, while still benefitting from good stability and weather protection closer to a shoreline in shallow water. Therefore, the benefits of offshore assembly are utilized while reducing the variability introduced by assembly in a deeper water location.

Transporting the completed wind vessel is performed using a transport vessel. The transport vessel may be any one of the semi-submergible vessel, a transport barge, a wet tow vessel (e.g., an offshore service vessel or “OSV”), or a dry tow vessel. The completed wind vessel may be disposed on top of the transport vessel or towed behind the transport vessel to the second offshore location. Transporting the completed wind vessel from an offshore location further enables shorter transfer times of each completed wind vessel compared to transporting a completed wind vessel from shore, since towing a completed wind vessel is slower than transporting wind vessel sub-components in a disassembled state.

The method 700 is part of a larger method of constructing a floating offshore wind field. Each of the wind vessel sub-components are manufactured offsite at one or more onshore locations. A first plurality of wind vessel sub-components are manufactured at one or more onshore locations before the first plurality of wind vessel sub-components are transported to a first offshore location as described in the method 700. The first plurality of wind vessel sub-components are assembled into a first floating offshore wind vessel at the first offshore location and transported from the first offshore location to the second offshore location as described in the method 700. Either subsequent to or simultaneously with the manufacture and assembly of the first offshore wind vessel and wind vessel sub-components, a second plurality of wind vessel sub-components are manufactured and transported to the first offshore location. The second plurality of wind vessel sub-components undergo a similar method to the first plurality of wind vessel sub-components and are assembled into a second floating offshore wind vessel at the first offshore location before being transported to the second offshore location. The second floating offshore wind vessel and the first floating offshore wind vessel are both positioned in the wind field. Additional floating offshore wind vessels are manufactured and assembled in a similar manner and transported to the wind field to complete a wind farm.

Each of the one or more onshore locations may be in a different location and may specialize in one or more of the wind vessel sub-components. In some embodiments, each of the one or more wind vessel sub-components are manufactured separately and then transported to a port close to the wind field, such that from the port the one or more wind vessel sub-components are transported to the first offshore location for assembly.

While the foregoing is directed to embodiments of the present disclosure, other and further embodiments of the disclosure may be devised without departing from the basic scope thereof, and the scope thereof is determined by the claims that follow.

What is claimed is:

1. A method of assembling a floating offshore wind vessel comprising:
transferring a plurality of wind vessel sub-components to a first offshore location;
assembling a first portion of a wind vessel on a semi-submersible vessel at the first offshore location;
assembling a second portion of the wind vessel on the first portion at the first offshore location to form a completed wind vessel;
partially submerging the semi-submersible vessel to float at least the first portion of the wind vessel; and
transferring the completed wind vessel from the first offshore location to a second offshore location.

2. The method of claim 1, wherein the second portion of the wind vessel is attached to the first portion of the wind vessel on the semi-submersible vessel.

3. The method of claim 1, wherein the second portion of the wind vessel is attached to the first portion of the wind vessel after at least one of:
floating the first portion of the wind vessel;
ballasting the first portion of the wind vessel; and
coupling the first portion of the wind vessel to an ocean floor.

4. The method of claim 1, wherein the first offshore location has a first water depth and the second offshore location has a second water depth, the first water depth less than the second water depth.

5. The method of claim 4, wherein the first water depth is less than about 150 feet.

6. The method of claim 5, wherein the second water depth is greater than about 100 feet.

7. The method of claim 1, wherein the semi-submersible vessel is a floating dry dock.

8. The method of claim 1, wherein a jack-up rig is at the first offshore location and is configured to assemble the wind vessel on the semi-submersible vessel.

9. The method of claim 8, wherein the jack-up rig includes one or more cranes.

10. A method of assembling a floating offshore wind vessel comprising:
assembling at least a portion of a wind vessel on an assembly deck of a semi-submersible vessel at the first offshore location from a plurality of wind vessel sub-components;
submerging the assembly deck of the semi-submersible vessel to float the wind vessel; and
transferring the completed wind vessel from the first offshore location to a second offshore location.

11. The method of claim 10, wherein the plurality of wind vessel sub-components are transported to the first offshore location in a disassembled state using a component transport vessel.

12. The method of claim 10, wherein the wind vessel sub-components comprise:
a lower platform;
a vessel column;
a nacelle; and
a plurality of turbine blades.

13. The method of claim 10, wherein the wind vessel sub-components comprise a plurality of turbine blades.

14. The method of claim 10, wherein the completed wind vessel is transported to the second offshore location after floating the wind vessel.

15. The method of claim 10, wherein assembling the wind vessel on the assembly deck comprises utilizing a jack-up rig positioned adjacent to the semi-submersible vessel at the first offshore location, a gantry crane positioned on the semi-submersible vessel, and a tower crane positioned on the semi-submersible vessel.

16. The method of claim 15, wherein the jack-up rig comprises a large capacity crane and a plurality of adjustable legs coupled to a portion of an ocean floor below the jack-up rig.

17. The method of claim 10, wherein the wind vessel is a floating offshore wind turbine.

18. The method of claim 10, wherein the first offshore location has a first water depth of less than 150 feet and the second offshore location has a second water depth, the first water depth less than the second water depth.

19. The method of claim 10, further comprising:
dry-towing a partially assembled wind vessel to the semi-submersible vessel, wherein the partially assembled wind vessel includes at least a lower platform and a vessel column; and
loading the partially assembled wind vessel onto the assembly deck of the semi-submersible vessel,
wherein assembling the at least a portion of the wind vessel comprises assembling a plurality of turbine blades on the partially assembled wind vessel.

20. A method of constructing a floating offshore wind field comprising:
manufacturing a first plurality of wind vessel sub-components at one or more onshore locations;
transferring the first plurality of wind vessel sub-components to a first offshore location;
assembling the first plurality of wind vessel sub-components into a first floating offshore wind vessel at a first offshore location;
transferring the first floating offshore wind vessel from the first offshore location to a second offshore location;
manufacturing a second plurality of wind vessel sub-components at the one or more onshore locations;
transferring the second plurality of wind vessel sub-components to the first offshore location;
assembling the second plurality of wind vessel sub-components into a second floating offshore wind vessel at the first offshore location; and
transferring the second floating offshore wind vessel from the first offshore location to the second offshore location.

21. The method of claim 20, wherein the assembling the first plurality of wind vessel sub-components into the first floating offshore wind vessel comprises:
assembling a first portion of the first floating offshore wind vessel on a semi-submersible vessel;
assembling a second portion of the first floating offshore wind vessel on the first portion to form a completed first floating offshore wind vessel; and
partially submerging the semi-submersible vessel to float at least the first portion of the wind vessel, wherein a jack-up rig is utilized during assembly of the first portion and the second portion.

22. The method of claim 20, wherein the first plurality of wind vessel sub-components comprises a hull, and further comprising, prior to assembling the first plurality of wind vessel sub-components into the first floating offshore wind vessel, at least one of:
ballasting the hull; and
coupling the hull to an ocean floor.
